(19) United States
(12) Patent Application Publication
(10) Pub. No.: US 2011/0202635 A1
(43) Pub. Date: Aug. 18, 2011

(54) POLICY CONTROLLER APPLICATION ENABLEMENT API FOR WIRELINE/WIRELESS CONVERGED SOLUTION

(75) Inventors: Lui Chu Yeung, Kanata (CA); Satvinder Bawa, Ottawa (CA); Lay Been Tan, Kanata (CA)

(73) Assignee: ALCATEL-LUCENT CANADA INC., Kanata (CA)

(21) Appl. No.: 13/030,460

(22) Filed: Feb. 18, 2011

Related U.S. Application Data
(60) Provisional application No. 61/305,770, filed on Feb. 18, 2010.

(51) Int. Cl. G06F 15/16; G06F 21/00

(52) U.S. Cl. 709/219; 726/3

(57) ABSTRACT

A method and apparatus are provided for allowing relatively simple interaction with a PCRF in an Evolved Packet Core. The PCRF includes an API, and instructions are sent by an application provider in an HTTP format to the API. The API translates these instructions into a diameter format so that they can be recognized by the PCRF. Response messages from the PCRF, in a diameter format, are sent to the API which translates these into a format recognized by the application provider's web browser.

### FIELD OF THE INVENTION

This invention relates to a PCRF within an Evolved Packet Core network, and more particularly to a method of communicating with a PCRF.

### BACKGROUND OF THE INVENTION

Long Term Evolution (LTE) is a framework for packet-based real-time and non-real-time services, and is proposed as the next framework used by the telecommunications industry. LTE provides many other advantages over the existing frameworks, such as more efficient use of radio spectrum. One aspect of the LTE framework is an Evolved Packet Core (EPC), an all-IP core, specified by the 3rd Generation Partnership Project (3GPP). The EPC provides mobile core functionality that, in previous mobile generations (2G, 3G), was realized through two separate sub-domains: circuit-switched for voice traffic and packet-switched for data. Using an EPC, a single all-IP domain is used.

The EPC has various components, including a Serving Gateway (SGW), a Packet Date Network Gateway (PGW), a Mobility Management Entity (MME), and a Policy and Charging Rules Function (PCRF). The PCRF is a concatenation of Policy Decision Functions and Charging Rules Functions. It supports service data flow detection, policy enforcement, and flow-based charging.

The PCRF receives messages from and sends messages to an Application Function (AF). An AF is a network element (or part of a network element) that supports applications that require dynamic policy and/or charging control. The AF is provided by a network provider or by an application provider. When there is a need for an application provided by the application provider, the AF communicates with the PCRF to request changes in policy and/or charging. For example, the AF may request that a dedicated pipe be established between a user requesting access to the application and the application server. As another example, the AF may request that any packets traveling from the application server to the user obey a different QoS than normal. As yet another example, the AF may request that the total volume of packets transferred to the user from the application server be monitored and charged for. Of course these are only examples, and in fact the AF may combine these actions.

According to the 3GPP specification, the PCRF receives and sends messages in a specific format. These messages are called Rx messages, and are in a format called Diameter. The Rx messages specified by the Diameter protocol are long, and can be difficult for a human to understand. A person programming an AF must be able to understand Rx messages, and someone unfamiliar with the Diameter format will have great difficulty in programming the AF. Furthermore, given the length and complexity of the Rx messages, interaction with the PCRF is prone to error even if the person programming the AF understands the Rx format. These problems are confounded by the fact that the Diameter format may change often, and the person programming the AF must keep up to date with the latest format recognized by the PCRF.

A solution which allowed communication with a PCRF using messages in a format more easy for a human to understand than the Diameter format would allow easier changing of dynamic policing and charging rules for a user's interaction with an application.

### SUMMARY OF THE INVENTION

According to one aspect, the invention provides a method of providing access to policing and charging functions within a PCRF. An HTTP message from an application is received. The HTTP message is converted to a Diameter message. The Diameter message is transmitted to a PCRF blade. A Diameter response message from the PCRF blade is received. The Diameter response message is converted to an HTTP response message. The HTTP response message is transmitted to the application. The HTTP message may be converted to a Diameter message by extracting an XML message from the HTTP message and converting the XML message to the Diameter message.

According to another aspect, the invention provides a non-transient computer-readable storage medium storing instructions which can be executed by a processor. The instructions include instructions for receiving an HTTP message; instructions for converting the HTTP message to a Diameter message; instructions for transmitting the Diameter message to a PCRF blade; instructions for receiving a Diameter message; instructions for converting the Diameter message to an HTTP message; and instructions for transmitting the HTTP message to an application. The instructions for converting the HTTP message to a Diameter message may include instructions for extracting an XML message from the HTTP message and instructions for converting the XML message to the Diameter message.

According to another aspect, the invention provides a PCRF. The PCRF includes a PCRF blade and an API. The API is able to receive an HTTP message and transmit an equivalent Diameter message to the PCRF blade, and to receive a Diameter message and output an equivalent HTTP message to an application. The API may also be able to an XML message from the received HTTP message and convert the XML message to the equivalent Diameter message.

The methods of the invention may be stored as processing instructions on non-transient computer-readable storage media, the instructions being executable by a computer processor.

The invention allows a simplified manner by which application providers and content providers can interact with a PCRF. By using an API, an application or content provider can use relatively simple HTTP messages to implement changes to charging and policy for specified customers or streams of data. HTTP is a good communication protocol to use because it is a commonly used protocol and can also be used through a firewall. The API generates the Diameter messages used by the PCRF, and hence a user wishing to alter charging or policy is shielded from the relative complexity of the Diameter messages, thereby reducing the likelihood of error.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a portion of a network in which the invention may be implemented;

FIG. 2 is a diagram of the interaction between an application and a PCRF of FIG. 1 according to one embodiment of the invention; and

FIG. 3 is a flowchart of a method carried out by the API of FIG. 2 according to one embodiment of the invention.

It is noted that in the attached figures, like features bear similar labels.

### DETAILED DESCRIPTION OF THE PREFERRED EMBODIMENTS

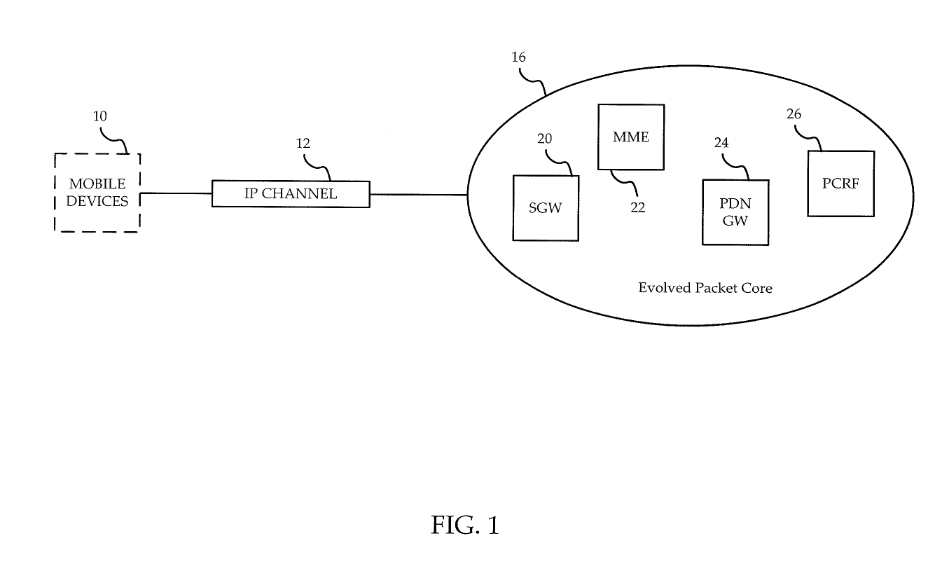

Referring to FIG. 1, a portion of a network in conformance with LTE is shown. Mobile devices 10 communicate over an IP channel 12 with an Evolved Packet Core (EPC) 16. The EPC 16 contains various components: a Serving Gateway (SGW) 20, a Mobility Management Entity (MME) 22, a Packet Data Network Gateway (PDN GW) 24, and a Policy and Charging Rules Function (PCRF) 26.

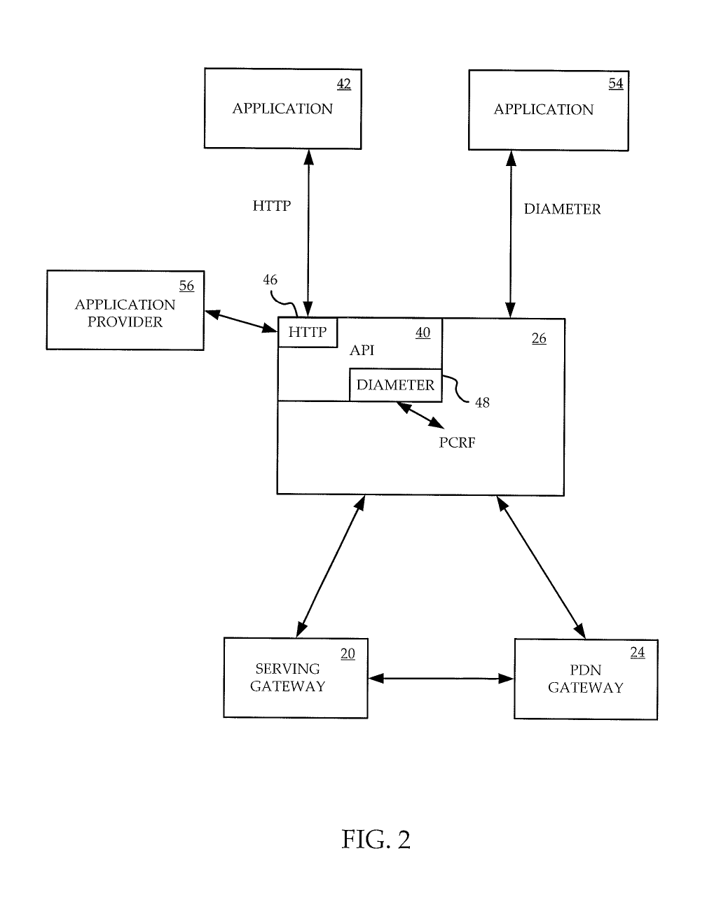

Referring to FIG. 2, the interaction between an application and the PCRF 26 according to one embodiment of the invention is shown. The PCRF 26 includes an Application Program Interface (API) 40. A first application 42 communicates with the PCRF 26 through the API 40 using HTTP messages. The API 40 includes an HTTP server 46 capable of receiving HTTP messages. The API 40 also includes a Diameter client 48 capable of transmitting Diameter messages to the rest of the PCRF 26, such as to one of a plurality of PCRF blades. The PCRF 26 can also receive Diameter messages from a second application function 54. An application provider 56 also communicates with the API 40, the application provider 56 being the operator of the first application 42.

Broadly, the API 40 acts as a translator, receiving HTTP messages as input, converting the HTTP messages to equivalent Diameter messages, and transmitting the Diameter messages. Similarly, the API receives Diameter messages as input, converting these Diameter messages to equivalent HTTP messages, and transmits the HTTP messages.

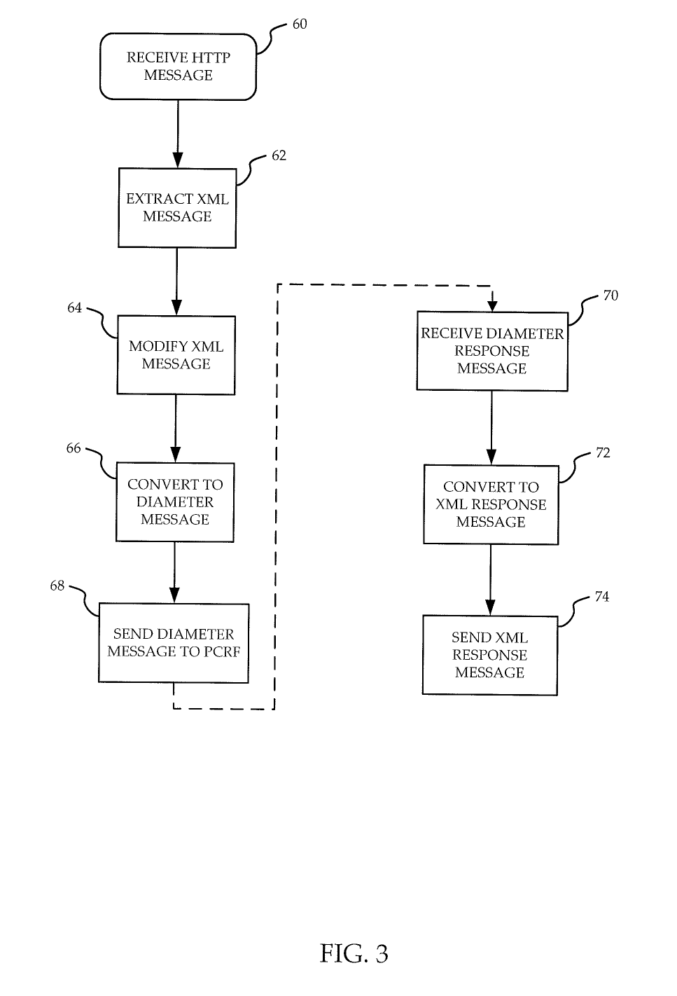

Referring to FIG. 3, flowchart of a method carried out by the API according to one embodiment of the invention is shown. At step 60 the API 40 receives an HTTP message. At step 62 the API 40 extracts an XML message from the HTTP message.

At step 64 the API 40 modifies the XML message using a template, if any template has been defined for this type of XML message. The creation of templates is described in more detail below.

At step 66 the API 40 converts the XML message, which may have been modified, to an equivalent Diameter message. At step 68 the API 40 transmits the Diameter message to other portions of the PCRF 26.

The API 40 should then receive a Diameter response message from the PCRF 26, and the remainder of the method is triggered at step 70 when this occurs. At step 72 the API 40 converts the Diameter response message to an XML message. At step 74 the API 40 transmits the XML message to the first application 42 as a payload of an HTTP response message. Alternatively, the API 40 may transmit the XML message to the first application 42 in a format specified by the user, in which case the API 40 supports HTTP content negotiation as the means to specify the format.

Similarly, the API 40 also provides a mechanism to carry out interactions which may be initiated by the PCRF 26. An aspect of session proxying is required to do this, and the API 40 has to act as an application gateway function proxy and hold the Diameter session to its logical completion. There is an aspect of notification handling from the PCRF 26 which the API 40 must relay back to the first application 42. The Diameter session is between the PCRF 26 and the API 40 rather than between the PCRF 26 and an application function directly, with Diameter messages from the PCRF 26 being translated into HTTP notification messages by the API 40 before being sent to the first application function 42, and HTTP response messages being translated into Diameter messages by the API 40 before being sent to the rest of the PCRF. The API 40 determines where to send the HTTP notification messages, i.e. the address of the HTTP server component of the first application 42, from the application specific data encoded in the Diameter session ID of the Diameter message and from the application settings provisioned by the application provider 56.

Characterizing features of the API 40 are: an easy to use interface, providing abstractions to complex data control attributes; use of commonly used internet protocols; providing the ability of a user to further customize messages to the PCRF 26; and the ability to maintain access to Rx attributes through relay capability.

The API 40 interface provides the capabilities to the first application 42 for setting up, altering, and removing of service data flows. The API 40 also provides the capabilities for provisioning application settings by the application provider 56 over the same HTTP protocol. One mandatory attribute in the application settings is the address of the HTTP server component of the first application 42, to which HTTP notification messages (translated form Diameter request messages initiated by the PCRF 26) to the first application 42 are sent. The HTTP communication channels between the API 40 and the first application 42 and those between the API 40 and the application provider 56 can be securely protected by using HTTPS (HTTP over TLS), which supports bi-directional PKI-certificate authentications and strong data encryption algorithms.

Diameter messages can require a lot of attributes, and a lot of information can be quite repetitive between different messages of the same type. To reduce the amount of data exchange required, and to some extent reduce the chances for errors, the API 40 provides support for Diameter in XML template format, with missing attributes filled in over the API 40 to make it easy to use Diameter. The API 40 supports pre-defined templates for common applications. Once communication between the application provider 56 and the API 40 is established, the application provider 56 may create templates which allow the pre-population of some fields when a user communicates with the API 40 through the first application 42. The application provider 56 may alternately set one or more values of pre-defined templates. If the use of templates is implemented, then XML messages may be modified at step 64 above by adding or modifying AVPs to the XML messages using one or more values in the templates so that the Diameter messages are more complete.

There may be additional, simplified APIs within the PCRF 26 for given application use cases, such as a video conference setup API, to setup flows of a given class of service between any two or more end points. The simplified APIs translate the application setup to Diameter, and perform any other required orchestration. Accounting correlation identifiers and/or subscription identifiers related to the flow may be used.

The API is preferably in the form of software, and may be stored as instructions on non-transient computer-readable storage media which can cause a computer processor to execute the methods of the API. Since the PCRF is also usually in the form of software, the API may be part of the PCRF. Alternatively, the API or any functionality of the API may be in the form of hardware.

The embodiments presented are exemplary only and persons skilled in the art would appreciate that variations to the embodiments described above may be made without departing from the spirit of the invention. The scope of the invention is solely defined by the appended claims.

I/We claim:

1. A method of providing access to policing and charging functions within a PCRF, comprising:
receiving an HTTP message from an application;
converting the HTTP message to a Diameter message;
transmitting the Diameter message to a PCRF blade;
receiving a Diameter response message from the PCRF blade;
converting the Diameter response message to an HTTP response message; and
transmitting the HTTP response message to the application.

2. The method of claim 1 wherein converting the HTTP message to a Diameter message comprises:
extracting an XML message from the HTTP message; and
converting the XML message to the Diameter message.

3. The method of claim 2 wherein converting the HTTP message to a Diameter message further comprises modifying the XML message prior to converting the XML message to the Diameter message.

4. The method of claim 3 wherein modifying the XML message comprises modifying the XML message using a template, and wherein the template contains values which allow the Diameter message created from the XML message to be more complete.

5. The method of claim 4 wherein at least one of the values is set by an application provider responsible for the application.

6. The method of claim 5 further comprising authenticating the application provider before allowing the application provider to set any of the values.

7. The method of claim 1 further comprising authenticating an application provider responsible for the application before allowing the application provider to provision the application.

8. The method of claim 1 wherein converting the Diameter response message to the HTTP response message comprises:
converting the Diameter response message to an XML message; and
including the XML message as a payload in the HTTP response message.

9. The method of claim 1 further comprising:
determining an address from application specific data within the session ID of a PCRF-initiated Diameter message and from application settings provisioned by an application provider responsible for the application;
converting the PCRF-initiated Diameter message to an HTTP message; and
transmitting the HTTP message to the address.

10. A non-transient computer-readable storage medium storing instructions which can be executed by a processor, the instructions comprising:
instructions for receiving an HTTP message;
instructions for converting the HTTP message to a Diameter message;
instructions for transmitting the Diameter message to a PCRF blade;
instructions for receiving a Diameter message;
instructions for converting the Diameter message to an HTTP message; and
instructions for transmitting the HTTP message to an application.

11. The non-transient computer-readable storage medium of claim 10 wherein the instructions for converting the HTTP message to a Diameter message comprise:
instructions for extracting an XML message from the HTTP message; and
instructions for converting the XML message to the Diameter message.

12. The non-transient computer-readable storage medium of claim 12 wherein the instructions for converting the HTTP message to a Diameter message further comprise:
instructions for modifying the XML message prior to converting the XML message to the Diameter message using a template, wherein the template contains values which allow the Diameter message created from the XML message to be more complete.

13. The non-transient computer-readable storage medium of claim 12 wherein the instructions further comprise instructions for accepting as input at least one value of the template.

14. The non-transient computer-readable storage medium of claim 10 wherein the instructions further comprise:
instructions for determining an address from application specific data within the session ID of a PCRF-initiated Diameter message and from application settings provisioned by an application provider responsible for the application;
instructions for converting the PCRF-initiated Diameter message to an HTTP message; and
instructions for transmitting the HTTP message to the address.

15. The non-transient computer-readable storage medium of claim 10 wherein the instructions further comprise instructions for authenticating an application provider responsible for the application before allowing the application provider to provision the application.

16. A PCRF comprising:
a PCRF blade; and
an API able to receive an HTTP message and transmit an equivalent Diameter message to the PCRF blade, and to receive a Diameter message and output an equivalent HTTP message to an application.

17. The PCRF of claim 16 wherein the API is able to extract an XML message from the received HTTP message and convert the XML message to the equivalent Diameter message.

18. The PCRF of claim 17 wherein the API is further able to modify the XML message prior to converting the XML message to the equivalent Diameter message using a template, wherein the template contains values which allow the Diameter message created from the XML message to be more complete.

19. The PCRF of claim 16 wherein the API is further able to authenticate an application provider responsible for the application before allowing the application provider to provision the application.

20. The PCRF of claim 16 wherein the API is further able to determine an address from application specific data within the session ID of a PCRF-initiated Diameter message and from application settings provisioned by an application provider responsible for the application, to convert the PCRF-initiated Diameter message to an HTTP message, and to transmit the HTTP message to the address.
